(19) United States
(12) Patent Application Publication
(10) Pub. No.: US 2003/0231418 A1
(43) Pub. Date: Dec. 18, 2003

(54) Storage medium disabling method and storage medium disabling apparatus

(75) Inventor: Shinichi Katsuda, Tokyo (JP)

Correspondence Address: SUGHRUE MION, PLLC, 2100 PENNSYLVANIA AVENUE, N.W., WASHINGTON, DC, 20037, US

(73) Assignee: NEC CORPORATION

(21) Appl. No.: 10/459,585

(22) Filed: Jun. 12, 2003

(30) Foreign Application Priority Data
Jun. 13, 2002 (JP) 2002-172335

(51) Int. Cl. B26D 1/00

(52) U.S. Cl. 360/55; 83/13; 83/684

(57) ABSTRACT

A storage medium disabling method and storage medium disabling apparatus renders a disposing optical disc unusable. The disposing optical disc has a data area on which data is recorded and a read-in area on which TOC information is recorded. The storage medium disabling method and storage medium disabling apparatus causes an irreversible change on a predetermined portion including a part of the read-in area to destroy continuity of TOC information, thereby rendering the optical disc unusable without a failure.

### BACKGROUND OF THE INVENTION

1. Field of the Invention

The present invention relates to a storage medium disabling method and storage medium disabling apparatus that make a storage medium for disposal be in an unusable condition to prevent data stored on the storage medium from being leaked to the third party.

2. Description of the Related Art

Generally, optical discs such as music CDs (Compact Discs), audio-visual DVDs (Digital Versatile Discs), etc. are subject to be an unusable condition at a disposing time to prevent music data and image data recorded thereon from being leaked to the third party.

There are various kinds of methods and apparatuses to make the disposing optical discs unusable condition. One well-known example is a method and apparatus that bends the optical disc. Another methods and apparatuses are disclosed in Unexamined Japanese Patent Application KOKAI Publication No. 2000-30302, Japanese Utility Model Registration No. 3034847 and Unexamined Japanese Patent Application KOKAI Publication No. H9-293348.

The method and apparatus that bends the disposing optical discs has a drawback in that the volume of bent optical discs is increased depending on the degree of bending. It does not matter if the amount of bent optical discs is relatively small, but if the amount of bent optical discs is relatively large, the bent optical discs would be bulky because of the increase in the volume at the time of putting them together. This causes uselessness of a space for putting the optical discs in unusable condition, resulting in inefficiency. If the optical disc is bent with the bending degree of not being bulky, then sufficient physical damage to make the optical disc be unusable is not applied to both the optical disc and data recorded on the optical disc.

Unexamined Japanese Patent Application KOKAI Publication No. 2000-30302 discloses an optical disc that is devised such that the recording area on which data is recorded can be peeled from the optical disc entirely. However, the method using this optical disc has a disadvantage that peeling the recording area from the optical disc substantially doubles the amount of the disposing optical disc. Accordingly, a volume of the space for placing the optical discs is also doubled, thus the method with this optical disc is inefficient.

The apparatus disclosed in Japanese Utility Model Registration No. 3034847 forms flaws on the entire surface of the disposing optical disc by using a brush, etc., thereby making data recorded on the optical disc substantially unreadable. However, this apparatus causes unevenness in flaws formed on the entire surface of the optical disc in case that the brush, etc. are worn due to the long-time use. For this reason, the optical disc cannot be certainly rendered unusable and data cannot be rendered unreadable in some cases. In considering maintenance for replacing the brush, etc., the method using this apparatus is complicated in the process , thus resulting in inefficiency.

The apparatus disclosed in Unexamined Japanese Patent Application KOKAI Publication No. H9-293348 forms cracks on the entire surface of the disposing optical disc by passing a punch, etc. throughout the disposing optical disc, thereby making the optical disc unusable. However, formation of cracks generates a large quantity of dust and fragments which will fly. Collection of the large quantity of flown dust and fragments is not easy to be carried out, thus the method using this apparatus is complicated, resulting in inefficiency.

As mentioned above, the conventional methods and apparatuses do not certainly make the disposing optical discs unusable and are complicated, thus inefficient in some cases.

### SUMMARY OF THE INVENTION

The present invention has been made with consideration given to the aforementioned circumstances, and an object of the present invention is to provide a storage medium disabling method and storage medium disabling apparatus that is capable of rendering a disposing storage medium unusable efficiently.

In order to attain the above object, a storage medium disabling apparatus according to a first aspect of the present invention is an apparatus that renders a disposing disc-like storage medium having one or a plurality of first areas on which data is recorded and one or a plurality of second areas on which specifying information for specifying contents of the data is recorded. The apparatus includes a processing section that causes an irreversible change on a predetermined portion for destroying said specifying information physically and rendering contents of said data unreadable, which is a part of the storage medium and which includes a part of the second area, and a jig that positions the predetermined portion of the storage medium and the processing section by placing the storage medium.

According to the above-structured storage medium disabling apparatus, the processing section causes the irreversible change such as deformation, deterioration, and the like on the second area on which information (for example, TOC information) for specifying the data recorded on the first area is recorded. This substantially destroys the information. Reading information recorded on the second area is indispensable when the storage medium drive device reads data from the storage medium. However, since this information is destroyed, the storage medium drive device cannot read data from the storage medium. Accordingly, the storage medium disabling apparatus can render the recording medium unusable certainly. Moreover, since the storage medium can be rendered unusable only by causing the change on only the predetermined portion, this storage medium disabling apparatus can render the storage medium unusable efficiently.

The processing section may include a punch blade for punching the predetermined portion from each storage medium.

The processing section may include a heating mechanism for heating and melting the predetermined portion.

The heating mechanism may include an electrically heated metallic wire.

The processing section may include a cutting blade that contacts with the predetermined portion to cut and shave the predetermined portion.

Moreover, in order to attain the above object, a storage medium disabling method according to a second aspect of the present invention is a method that renders a disposing disc-like storage medium having one or a plurality of first areas on which data is recorded and one or a plurality of second areas on which specifying information for specifying contents of the data is recorded. The method includes the step of causing an irreversible change on a predetermined portion of the storage medium including a part of the second area to render the specifying information recorded on the second area unreadable and the storage medium unusable.

According to the above method, the irreversible changes such as deformation, deterioration, and the like are caused on the second area on which information (for example, TOC information) for specifying data recorded on the first area is recorded. This substantially destroys the information. Reading information recorded on the second area is indispensable when the storage medium drive device reads data from the storage medium. However, since this information is destroyed, the storage medium drive device cannot read data from the storage medium. Accordingly, this method can render the recording medium unusable without fail. Moreover, since the storage medium can be rendered unusable by such a local process that the change is caused on only the predetermined portion, this method is relatively easy. Therefore, this method is efficient.

In the step, the predetermined portion may be punched from the storage medium by a punching blade.

In the step, an electrically heated metallic wire may be pressed onto the predetermined portion to heat and melt the predetermined portion.

In the step, the predetermined portion may be cut and shaved by a cutting blade that contacts with the predetermined portion.

Moreover, in order to attain the above object, a storage medium disabling method according to a third aspect of the present invention is a method that renders a disc-like storage medium having a first area on which data is recorded by arraying a plurality of pits and a second area on which TOC information on the data is recorded by arraying a plurality of pits, wherein an irreversible change is added onto the array of pits corresponding to the TOC information to destroy continuity of the TOC information and to render the storage medium unusable.

According to this method, the irreversible change is added onto the array of pits corresponding to TOC information. For this reason, continuity of the TOC information is substantially destroyed. Reading TOC information is indispensable when the storage medium drive device reads data from the storage medium. However, since continuity of the TOC information is destroyed, the storage medium drive device cannot read data from the storage medium. Accordingly, this method can render the recording medium unusable without fail. Moreover, since the storage medium can be rendered unusable only by causing the irreversible change on only the portion of the pit array, the process is relatively easy. Therefore, this method is efficient.

### BRIEF DESCRIPTION OF THE DRAWINGS

These objects and other objects and advantages of the present invention will become more apparent upon reading of the following detailed description and the accompanying drawings in which:

FIG. 1A is a plane view illustrating one example of the structure of optical disc used in an embodiment of the present invention, FIG. 1B is a plane view illustrating one example of an optical disc to which a storage medium disabling method according to the embodiment of the present invention is applied;

FIG. 2 is a block diagram illustrating one example of the structure of the storage medium disabling apparatus according to the embodiment of the present invention;

FIGS. 3A and 3B are side views each illustrating one example of the storage medium disabling apparatus;

FIG. 4A is a side view illustrating a state in which a plurality of optical discs rendered unstable by bending is stacked on top of each other, and FIG. 4B is a side view illustrating a state in which a plurality of optical discs, to which the storage medium disabling method according to the first embodiment is applied, is stacked on top of each other;

FIG. 5A is a plane view explaining modification 1 of the first embodiment of the present invention, and FIG. 5B is a perspective view illustrating one example of the punch blade that the storage medium disabling apparatus according to modification 1 of the first embodiment has;

FIG. 6A is a plane view explaining modification 2 of the first embodiment of the present invention, and FIG. 6B is a side view illustrating one example of the storage medium disabling apparatus according to modification 2 of the first embodiment;

FIG. 7A is a plane view explaining modification 3 of the first embodiment of the present invention, and FIG. 7B is a perspective view illustrating one example of the punch blade which the storage medium disabling apparatus according to modification 3 of the first embodiment has;

FIG. 8 is a side view showing the structure of the storage medium disabling apparatus used in modification 4 of the first embodiment;

FIGS. 9A to 9C are views each explaining the structure of the storage medium disabling apparatus according to the second embodiment of the present invention; and

FIGS. 10A and 10B are plane views each illustrating the optical disc in which a predetermined portion is cut by a storage medium disabling method according to a second embodiment.

### DETAILED DESCRIPTION OF THE PREFERRED EMBODIMENTS

The following will specifically explain a storage medium disabling method and a storage medium disabling apparatus according to the embodiments of the present invention with reference to the drawings.

(First Embodiment)

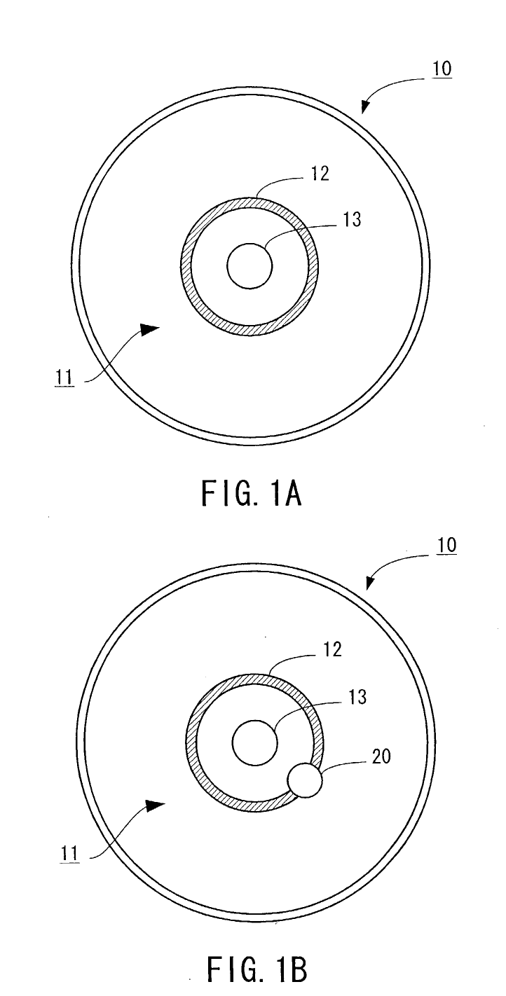

A storage medium disabling method according to this embodiment makes a disposing disc-like storage medium such as a CD (Compact Disc) and a DVD (Digital Versatile Disc), etc., which is namely a disposing optical disc, unusable. As illustrated in FIG. 1A, an optical disc 10 includes a data area 11 and a read-in area 12 with a predetermined distance from a center hole 13.

On the data area 11, music data, image data, and the like are recorded. On the other hand, on the read-in area 12, information that a disc drive device such as CD player needs to read out the data recorded on the data area 11, is recorded. This information and the data recorded on the data area 11 are recorded on the data area 11 and the read-in area 12 as a so-called “pit array”.

One example of the information that is necessary for a disc drive device to read out the data recorded on the data area 11 is TOC (Table Of Contents) information. In case that the optical disc 10 comprises a CD, TOC information includes information for specifying contents of the data recorded on the data area 11(information representing a kind of the optical disc 10, information representing a number of music pieces recorded on the data area 11, start address information and end address information of the data recorded on the data area 11, etc.). In general, an optical disc drive device first specifies contents of the data recorded on the data area 11 by reading TOC information recorded on the read-in area 12 when the optical disc 10 is loaded.

For this reason, the storage medium disabling method causes irreversible changes (for example, deformation in a pit array, deterioration in the reflection rate of read-in area 12, etc.) on a predetermined portion including at least a part of the read-in area 12 to destroy TOC information physically. This makes the optical disc 10 substantially unusable. In the present embodiment, the information necessary for reading out the data recorded on the data area 11 will be specifically explained by employing TOC information as an example.

More specifically, as illustrated in FIG. 1B, the storage medium disabling method includes a step of punching out a predetermined circular portion 20, which includes the part of the read-in area 12 with a predetermined distance from the center hole 13, from the optical disc 10. This makes TOC information recorded on the read-in area 12 unreadable and data recorded on the data area 11 unreadable, so that the optical disc 10 is to be substantially unusable. In addition, according to the storage medium disabling method, the optical disc 10 may be unusable one by one, or the plurality of optical discs 10 may be rendered unusable at one time.

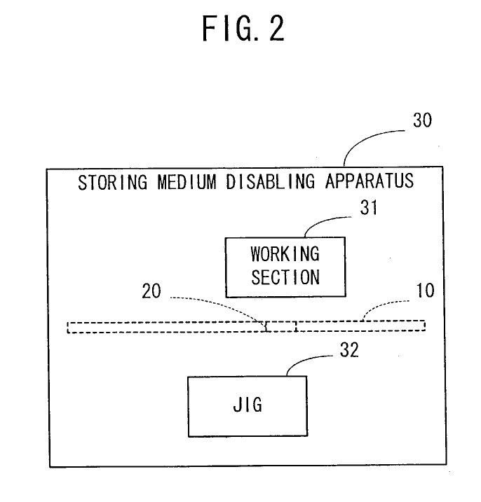

Accordingly, the apparatus for carrying out storage medium disabling method (hereinafter, referred to as storage medium disabling apparatus) is one that punches the predetermined portion 20 from the optical disc 10. As illustrated in FIG. 2, a storage medium disabling apparatus 30 includes: a working section 31 that punches out the predetermined portion 20 from the optical disc 10; and a jig 32 that positions the optical disc 10 such that the working section 31 is pressed onto the predetermined portion 20 locating in a predetermined distance from the center hole 13. Examples of the above-structured storage medium disabling apparatus are a punch type press (punch), a drill with a hole saw, an apparatus that presses an electrically heated nichrome wire onto the optical disc 10, and a melting apparatus such as an ultrasonic welder.

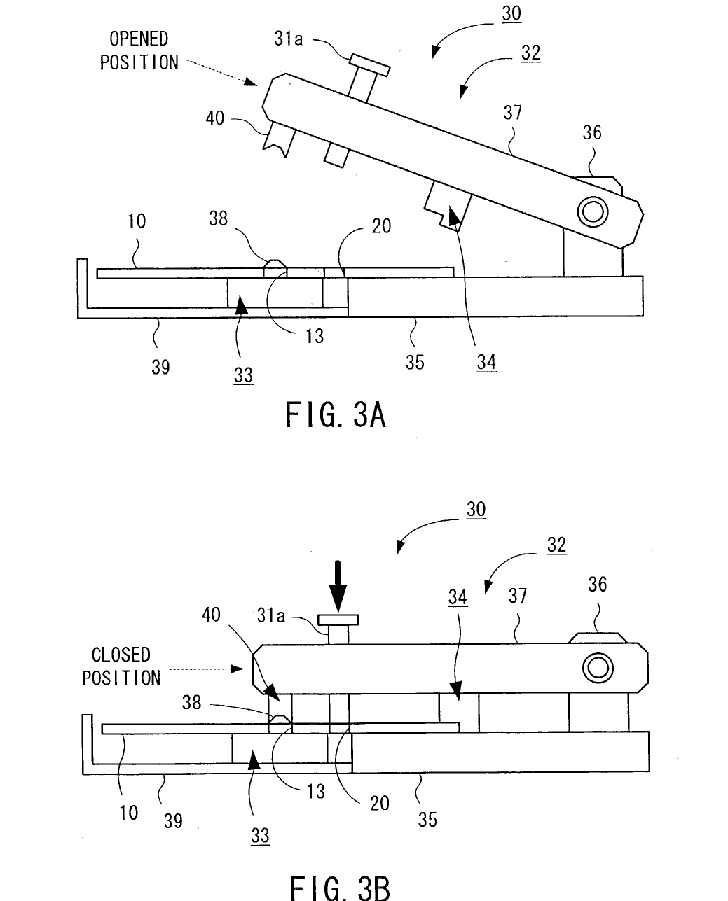

In the present embodiment, the punch is used as the storage medium disabling apparatus 30. One example of this storage medium disabling apparatus 30 is illustrated in FIGS. 3A and 3B. As illustrated in the figures, the storage medium disabling apparatus 30 includes a punch working section 31a, and a jig 32 comprising a first holder 33, a second holder 34, a base 35, an arm stand 36, and an arm 37. The storage medium disabling apparatus 30 punches out the predetermined portion 20 from one optical disc 10 at one time.

Seeing from the side surface, the first holder 33 has substantially square shape. And the first holder 33 has a projection 38 having substantially the same diameter as the center hole of the optical disc 10, at the upper surface thereof. The projection 38 is passed through the center hole 13, and thereby placing the optical disc 10 on its upper surface.

As shown in FIG. 3B, the second holder 34 comes in contact with the outer periphery (edge) of the optical disc 10 placed on the first holder 33, thereby pressing and holding the optical disc 10 downwardly (from top to down in the figure).

The base 35 has a substantially square shape and fixes a tray 39 to its one side surface. The first holder 33 is slidably placed on the tray 39. The base 35 places an outer periphery neighborhood portion of the optical disk 10 (portion of the optical disk 10 pressed downward by the second holder 34) onto the surface horizontally plane with the upper surface of the first holder 33 placed on the tray 39. Regarding the upper surface of the base 35 (plane where the outer periphery neighborhood portion of the optical disc 10), on the surface where the outer periphery neighborhood portion of the optical disc 10 is not placed, the arm stand 36 is provided in a fixing manner to extend to a vertical direction (upper direction in the figure).

In addition, as illustrated in the figure, a space whose width is substantially the same as the diameter of the predetermined portion 20, is formed between one side surface of the base 35 and the first holder 33.

Seeing from the side surface, the arm stand 36 rotatably fixes one end of the arm 37 having a substantially rectangular shape.

The arm 37 moves between an opened position shown in FIG. 3A and a closed position shown in FIG. 3B with its one end rotatably fixed to the arm stand 36 as a center of rotation. A projection 40, which is coaxially engaged with the projection 38 of the first holder 33 at the closed position, is fixed to the other end of the arm 37. The projection 38 and the projection 40 are engaged with each other, thereby preventing the first holder 33 from being rattled in the tray 39.

The second holder 34 is fixed to a predetermined portion between one end of the arm 37 and the other end thereof so that the second holder 34 can press the outer periphery portion of the optical disc 20 in a state that the arm 37 is placed at the closed position. Accordingly, in the state that the arm 37 is placed at the closed position, the second holder 34 fixes the outer periphery portion of the optical disc 10. On the other hand, in the state that the arm 37 is placed at the opened position, the second holder 34 releases the outer periphery portion of the optical disc 10 according to movement of the arm 37.

Furthermore, the punch working section 31a is attached to a predetermined portion between the second holder 34 and the projection 40. The working section 31a vertically opposes to the predetermined portion 20 of the optical disc 10 in a state that the arm 37 is placed at the closed position.

The punch working section 31a includes a punch blade with a cylindrical shape. The punch working section 31a is attached to a predetermined portion of the arm 37 through a spring (not shown) to be reciprocatable in up and down directions.

In the above-structured storage medium disabling apparatus 30, the projection 38 of the first holder 33 is passed through the center hole 13 of the optical disc 10 in a state that the arm 37 is placed at the opened position. The arm 37 is moved to the closed position, and thereby the respective structural elements of the jig 32 align the predetermined portion 20 of the optical disc 10 and the punch working section 31a.

The punch working section 31a is pressed in the direction of an arrow shown in FIG. 3B, and thereby the punch working section 31a contacts with the predetermined portion 20 of the optical disc 10. The punch working section 31a is further pressed. In this state, one of the side surfaces of the base 35 fixing the tray 39 and a side surface of the first holder 33 facing to the side surface of the base 35 fixing the tray 39, function as a die. The predetermined portion 20 is punched out from the optical disc 10 by the punch working section 31a and the die. The fragment of the optical disc 10 obtained by punching the predetermined portion 20 is contained in a space formed between one side surface of the first holder 33 and one side surface of the base 35.

In this way, the predetermined portion 20 including the part of the read-in area 12 is punched out from the optical disc 10, and thereby the pit array shape is destroyed and continuity of TOC information recorded on the read-in area 12 is destroyed. For this reason, even if the optical disc 10 from which the predetermined portion 20 is loaded on an optical disc drive device such as a CD player, etc., the optical disc 10 is not recognized by the optical disc drive device. Accordingly, it is certainly possible to make the optical disk 10 in an unusable condition with the process that the predetermined portion 20 is punched from the optical disc 10. Additionally, as compared with the process in which cracks are formed, the amount of generated dust and fragments in this process is small.

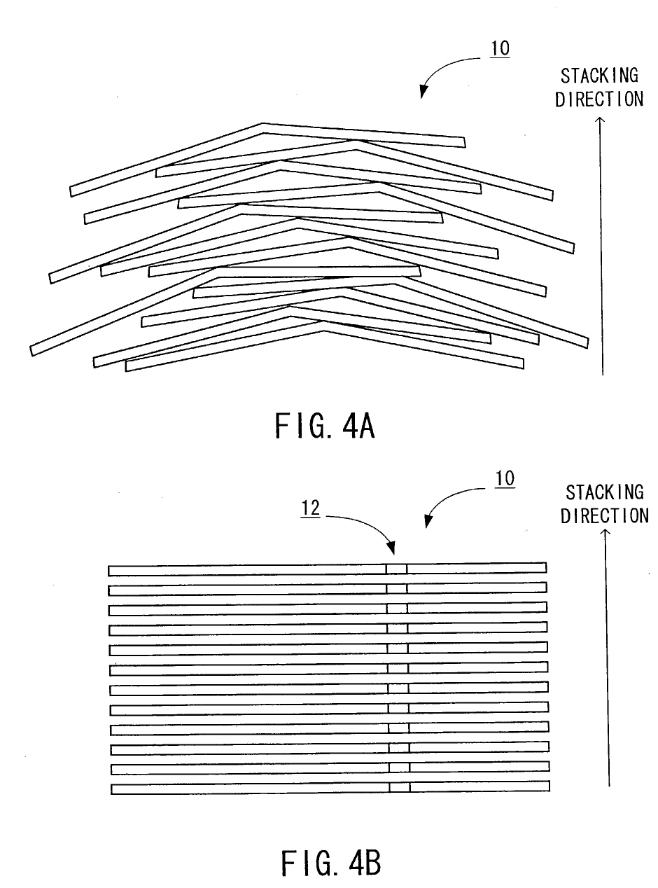

Moreover, according to the present embodiment, the degree of the entire deformation of the unusable optical disc 10 is small as compared with the bent optical disc. For example, even if the bent optical discs 10 are stacked on top of each other to be put together in a compact form, they are bulky as illustrated in FIG. 4A, so that a useless space is formed in the stacking direction. On the other hand, the optical discs 10, which are rendered unusable by the storage medium disabling method and storage medium disabling apparatus according to this embodiment, can be easily stacked on top of each other as illustrated in FIG. 4B. For this reason, even when the optical disc 10 rendered unusable and the fragment obtained by punching the predetermined portion 20 are stored, the storing space can be relatively easily ensured.

Because the disposing optical disc 10 can be rendered unusable certainly, and treatment after making the disposing optical disc 10 unusable is relatively easy, the storage medium disabling method and storage medium disabling apparatus according to this embodiment are efficient.

In addition, the fragment obtained by punching the predetermined portion 20 and the optical disc 10 are preferably discarded separately. This makes it possible to prevent such a situation that the third party obtains both the optical disc 10 and the fragment and fills the fragment in the predetermined portion 20 of the optical disc 10 to try the playback of the optical disc 10. Namely, the risk of data leakage can be reduced.

(Modification 1 of the First Embodiment)

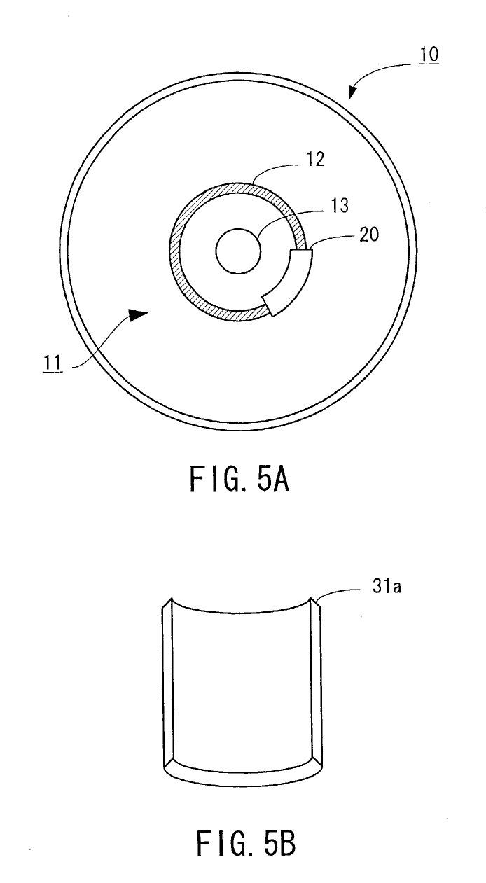

The predetermined portion 20 may have any shape without being limited to the circular shape. For example, as illustrated in FIG. 5A, the predetermined portion 20 may be strap-shaped along the shape of the read-in area 12. In this case, the punch blade 31a may have a shape illustrated in FIG. 5B. Even if the predetermined portion 20 has any shape, the same effect as the aforementioned embodiment can be obtained. However, it is indispensable that the predetermined portion 20 should include the part of the read-in area 12.

(Modification 2 of the First Embodiment)

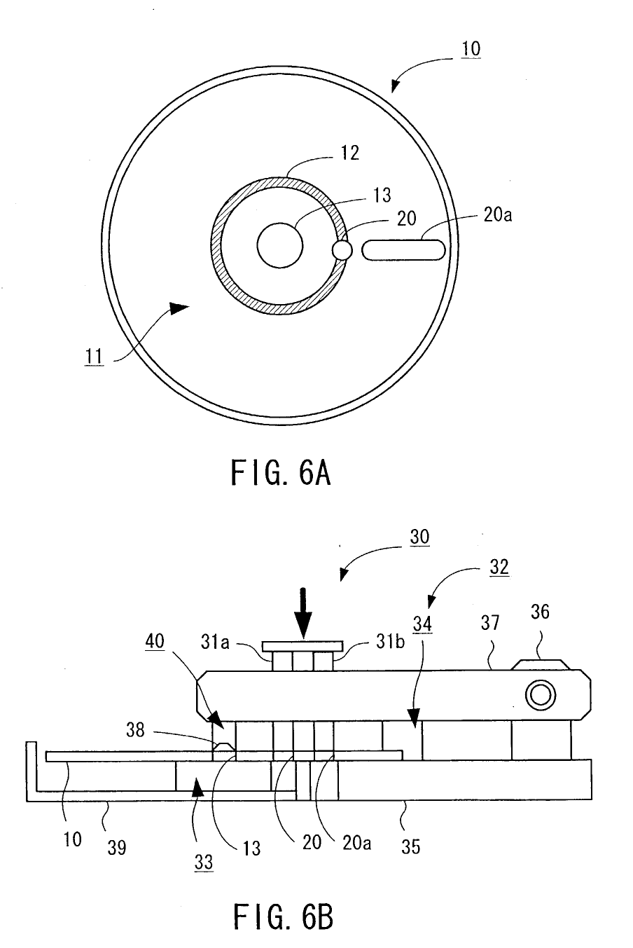

Reducing the risk of data leakage further, the predetermined portion 20 including the part of the read-in area 12 and a predetermined portion 20a including the part of the data area 11 may be punched out from the optical disc 10 as illustrated in FIG. 6A.

In this case, the storage medium disabling apparatus 30 may have a press-type punch blade 31b in addition to have the punch blade 31a. In a state that the arm 37 is placed on the closed position, the storage medium disabling apparatus 30 punches out the predetermined portions 20, 20a by the punch blades 31a, 31b pressed in.

This destroys not only continuity of TOC information recorded on the read-in area 12 but also continuity of data recorded on the data area 1. Accordingly, the risk of data leakage can be more reduced.

(Modification 3 of the First Embodiment)

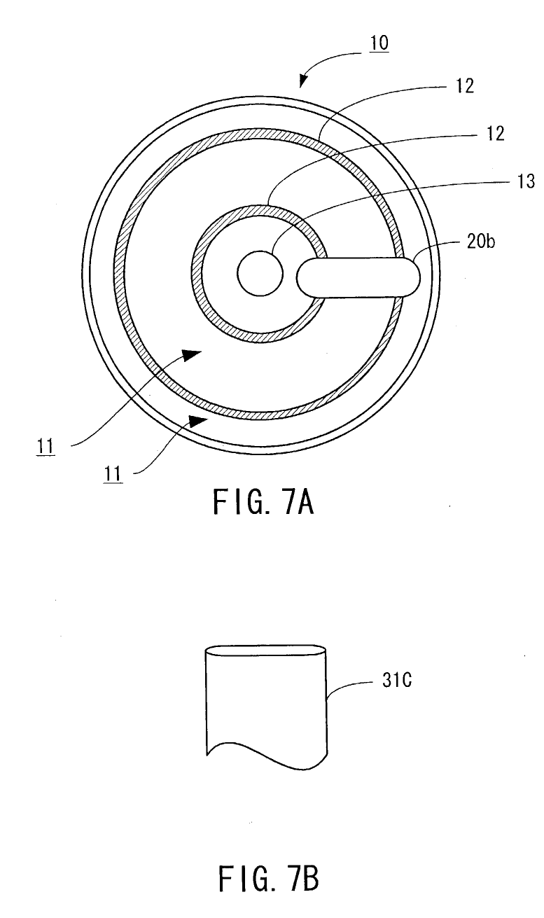

There is a case in which the optical disc 10 is a multisession optical disc having a plurality of data areas 11 and a plurality of read-in areas 12 corresponding to the respective data areas 11 as illustrated in FIG. 7A. In this case, the predetermined portion 20 may be punched for each read-in area 12. However, this is complicated since the number of punching times is increased.

For this reason, in such a case, the predetermined portion 20 may include the part of each read-in area 12. This makes it possible to render the optical disc 10 unusable certainly by one punching process.

More specifically, the storage medium disabling apparatus 30 preferably has a punch blade 31c with a substantially elliptic shape as shown in FIG. 7B. In this case, the storage medium disabling apparatus 30 punches out the predetermined portion 20 with a substantially elliptic shape which includes the part of each of the plurality of read-in areas 12, from the optical disc 10. This makes it possible to destroy the continuity of TOC information recorded on each read-in area 12 of the multisession optical disc 10.

(Modification 4 of the First Embodiment)

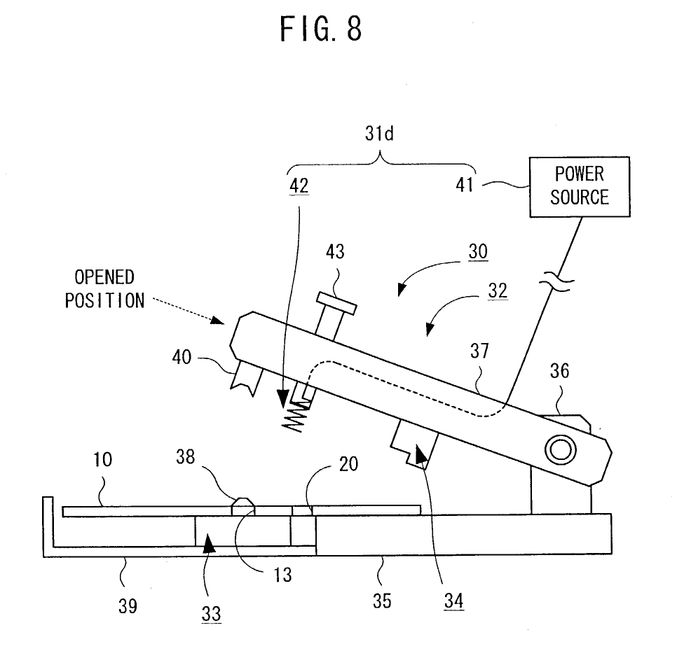

In a case that the storage medium disabling apparatus 30 comprises a melting apparatus that presses electrically heated metal wire onto the predetermined portion 20 of the optical disc 10, the storage medium disabling apparatus 30 may have a structure such as shown in FIG. 8. As illustrated, the storage medium disabling apparatus 30 has the same structure shown in FIG. 2A and FIG. 2B except a heating mechanism 31d.

The heating mechanism 31d includes a power source 41 and a metal wire 42 electrically connected to the power source 41.

The power source 41 supplies electrical power to the metal wire 42.

The metal wire 42 is electrically heated by power supplied from the power source 41. The metal wire 42 comprises nichrome wire, etc., and has a coil shape. The metal wire 42 is attached to one end of a cylinder 43 which is attached to a predetermined portion of the arm 37 through a spring (not shown) to be reciprocatable in up and down directions.

In the above-structured storage medium disabling apparatus 30, the metal wire 42 is electrically heated by power supplied from the power source 41. In a state that the arm 37 is in the closed position, the cylinder 43 is pressed, and the metal wire 42 attached on one end of the cylinder 43 comes in contact with the predetermined portion 20 of the optical disc 10. The cylinder 43 is further pressed and the metal wire 42 punches out the predetermined portion 20 by melting. Thus the storage medium disabling apparatus 30 having the above structure can attain the same effect as that of punch-type.

(Second Embodiment)

This embodiment is a storage medium disabling method and storage medium disabling apparatus that causes irreversible changes (deformation, deterioration and the like) on the predetermined portion 20 without punching out the predetermined portion from the optical disc 10.

The storage medium disabling apparatus 30 according to this embodiment is composed of, for example, a device that forms flows on the predetermined portion 20 or a melting device that heats the predetermined portion 20 and emits an ultrasonic wave to the predetermined portion 20. The storage medium disabling apparatus 30 includes at least the working section 31 that adds irreversible changes to the predetermined portion 20 with a distance from the center hole 13 and the jig 32 that positions the optical disc 10.

The storage medium disabling apparatus according to this embodiment may render the optical disc 10 unusable one by one, or the plurality of optical discs 10 unusable at one time, similar to the apparatus descried in the first embodiment.

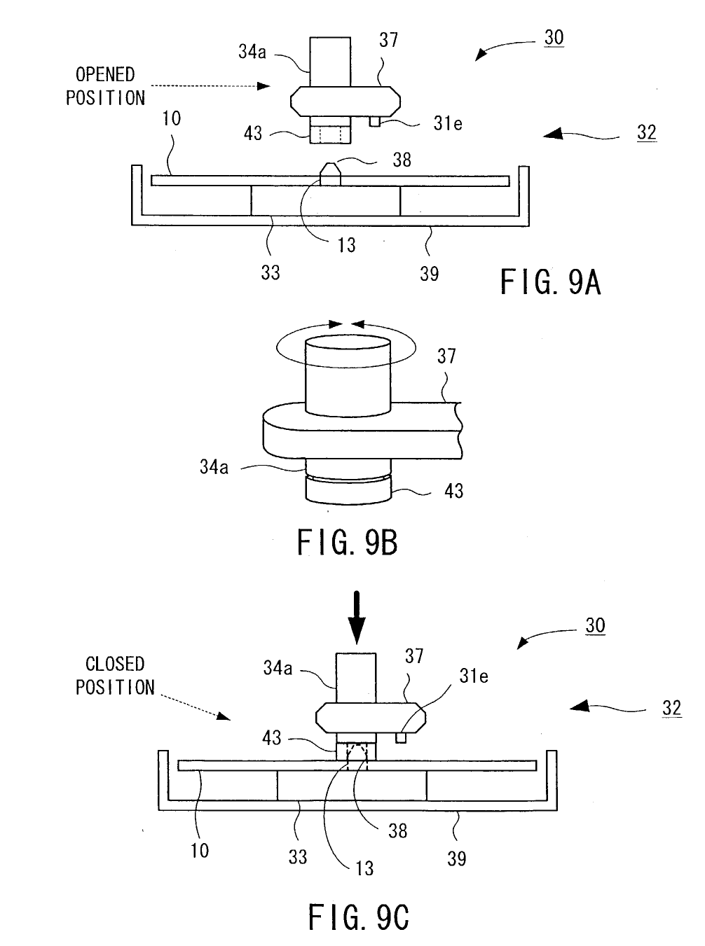

For example, in a case where the storage medium disabling apparatus is composed of the device that forms flaws on the predetermined portion 20, the storage medium disabling apparatus 30 may have a structure such as shown in FIGS. 9A to 9C, instead of the structure shown in FIGS. 3A and 3B. As illustrated, the storage medium disabling apparatus includes a cutting blade 31e as the working section 31, and jig 32 comprising a first holder 33, a second holder 34a, an arm 37 and a tray 39.

The first holder 33 has the same structure as the first holder 33 shown in FIGS. 3A and 3B.

The second holder 34a has a circular cylindrical shape and has a rotating mechanism 43 at one end thereof. As shown in FIG. 9B, the rotating mechanism 43 rotatably fixes one end of the second holder 34a. As shown in FIG. 9C, the rotating mechanism 43 has an opening for fitting the projection 38 of the first holder 33. The second holder 34a sandwiches the optical disc 10 with the first holder 33 by fitting the projection 38 into the opening of the rotating mechanism 43. The second holder 34a further holds one end of the arm 37.

The arm 37 rotates with the second holder 34a. The cutting blade 31e as the working section 31 is attached onto the other end of the arm 37. The arm 37 aligns the predetermined portion 20 with a predetermined distance from the center hole 13, and the cutting blade 31e.

The first holder 33 is placed at the center of the tray 39. The tray 39 receives and collects fragments, etc. generated by cutting.

In the above-structured storage medium disabling apparatus 30, the projection 38 of the first holder 33 is passed through the center hole 13 of the optical disc 10 in a state that the second holder 34a and the arm 37 are placed at a opened position. From this state, the second holder 34a and the arm 37 are placed at a closed position by the projection 38 fitting into the opening of the rotating mechanism 43 as shown in FIG. 9C.

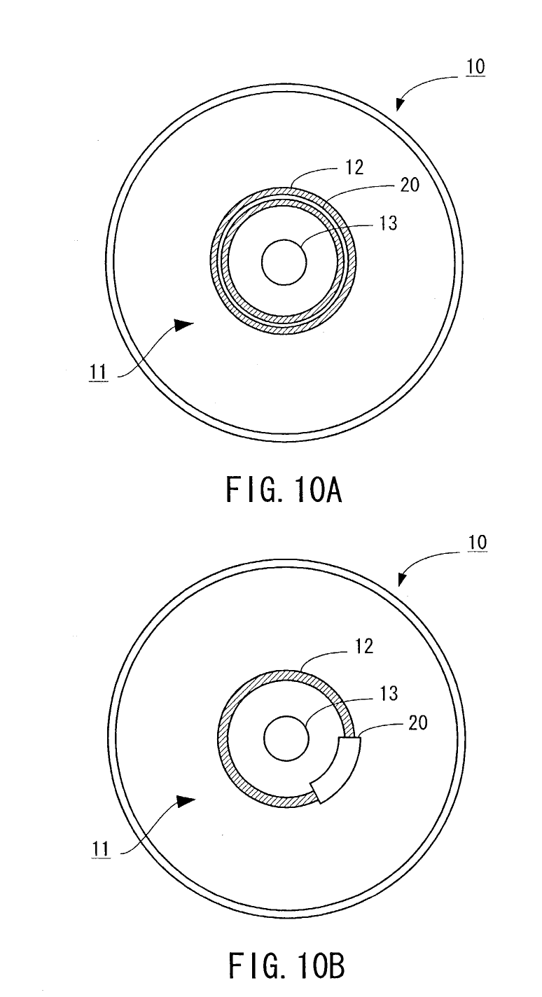

The second holder 34a is pressed in the direction of an arrow shown in FIG. 9C, and thereby the portion of the optical disc 10 near the center hole 13 is pressed by the rotating mechanism 43. The optical disc 10 is firmly placed onto the upper surface of the first holder 33, and the cutting blade 31e comes in contact with the predetermined portion 20 of the optical disc 10. From this state, the second holder 34a is rotated, thereby the cutting blade 31e forms a flaw onto the predetermined portion 20 along the read-in area 12 by cutting (and shaving), as shown in FIG. 10A or FIG. 10B.

An irreversible change (deformation) is caused on the pit shape of the read-in area 12 by cutting, and TOC information recorded on the read-in area 12 is substantially destroyed. Thus this makes it possible to render the optical disc 10 unusable.

On the other hand, in a case where the storage medium disabling apparatus 30 is composed of the heating and melting device, the storage medium disabling apparatus 30 includes an electrically heated nichrome wire, a laser irradiation mechanism, etc. as the working section 31. In this case, the storage medium disabling apparatus 30 provides heat treatment to the predetermined portion 20 including at least a part of the read-in area 12 as illustrated in FIG. 1B, FIGS. 5 to 7. Additionally, the heat treatment may be contact heating or non-contact heating.

The pit shape of the predetermined portion 20 is irreversibly deformed by the heating and melting and the characteristic of the predetermined portion 20 such as a reflection rate deteriorates, so that continuity of TOC information recorded on the read-in area 12 is substantially destroyed. This makes the optical disc 10 be in an unusable condition.

As described above, the storage medium disabling apparatus and storage medium disabling method according to this embodiment causes the irreversible change on only the predetermined portion 20 of the entire surface of the optical disc 10, and the process is relatively easy. Moreover, the irreversible change is caused on the predetermined portion 20, making it possible to render the optical disc 10 unusable without a failure.

Further, the storage medium disabling method and storage medium disabling apparatus according to this embodiment renders the optical disc 10 unusable reliably without punching out the predetermined portion 20 from the optical disc 10. Accordingly, as a treatment such that disposing the fragment generated by punching is not necessary, the process after rendering the disposing optical disc 10 unusable can be relatively easy.

Therefore, the storage medium disabling method and storage medium disabling apparatus according to this embodiment is efficient.

The present invention is not limited to the above embodiments. For example, the first and second embodiments have explained the case in which the storage medium is composed of the optical disc such as CD or DVD. However, any kinds of storing media having the data area recording data and the area recording information such as TOC may be used.

More specifically, the storage medium may be composed of an optical magnetic disc such as MD. In this case, the storage medium disabling method according to the first and second embodiments may be applied in a state that MD is unloaded from the cartridge.

It is assumed that the optical disc used in the first and second embodiments has an arbitrary size. The optical disc may have any diameter size of, for example, 12 cm, 8 cm, 3 cm, or 3.5 in.

Various embodiments and changes may be made thereunto without departing from the broad spirit and scope of the invention. The above-described embodiments are intended to illustrate the present invention, not to limit the scope of the present invention. The scope of the present invention is shown by the attached claims rather than the embodiments. Various modifications made within the meaning of an equivalent of the claims of the invention and within the claims are to be regarded to be in the scope of the present invention.

This application is based on Japanese Patent Application No. 2002-172335 filed on Jun. 13, 2002 and including specification, claims, drawings and summary. The disclosure of the above Japanese Patent Application is incorporated herein by reference in its entirety.

What is claimed is:

1. A storage medium disabling apparatus that renders a disposing disc-like storage medium be in an unusable condition, the disc-like storage medium (10) having one or a plurality of first areas on which data is recorded and one or a plurality of second areas on which specifying information for specifying contents of said data is recorded, said apparatus comprising:
a processing section that causes an irreversible change on a predetermined portion for destroying said specifying information physically and rendering contents of said data unreadable, which is a part of said storage medium and which includes a part of said second area; and
a jig that positions the predetermined portion of said storage medium and said processing section by placing said storage medium.

2. The apparatus according to claim 1, wherein said processing section includes a punch blade for punching the predetermined portion from each storage medium.

3. The apparatus according to claim 1, wherein said processing section includes a heating mechanism for heating and melting the predetermined portion.

4. The apparatus according to claim 1, wherein the heating mechanism includes an electrically heated metallic wire.

5. The apparatus according to claim 1, wherein said processing section includes a cutting blade that contacts with the predetermined portion to cut and shave the predetermined portion.

6. A storage medium disabling method, which is a method that renders a disposing disc-like storage medium having one or a plurality of first areas on which data is recorded and one or a plurality of second areas on which specifying information for specifying contents of said data is recorded, said method comprising the step of causing an irreversible change on a predetermined portion of said storage medium including a part of said second area to render specifying information recorded on the second area unreadable and said storage medium unusable.

7. The method according to claim 6, wherein in said step, the predetermined portion is punched from said storage medium by a punching blade.

8. The method according to claim 6, wherein in said step, an electrically heated metallic wire is pressed onto the predetermined portion to heat and melt the predetermined portion.

9. The method according to claim 6, wherein in said step, the predetermined portion is cut and shaved by a cutting blade that contacts with the predetermined portion.

10. A storage medium disabling method, which is a method that renders a disc-like storage medium having a first area on which data is recorded by arraying a plurality of pits and a second area on which TOC information on said data is recorded by arraying a plurality of pits, wherein an irreversible change is added onto the array of pits corresponding to said TOC information to destroy continuity of said TOC information and to render said storage medium unusable.
